(19) United States
(12) Patent Application Publication
(10) Pub. No.: US 2012/0091623 A1
(43) Pub. Date: Apr. 19, 2012

(54) METHOD TO MANUFACTURE CHROME BUTTONS WITH INTEGRATED LIGHT PIPE USING TWO SHOT MOLDING PROCESS

(75) Inventor: Erik Anthony Wippler, Canton, MI (US)

(73) Assignee: Toyota Motor Engineering & Manufacturing North America, Inc., Erlanger, KY (US)

(21) Appl. No.: 12/906,280

(22) Filed: Oct. 18, 2010

(51) Int. Cl. B29C 70/68; B29C 71/00; B29C 45/00

(52) U.S. Cl. 264/232

(57) ABSTRACT

The present invention provides a method for molding and chrome plating a button having an integrated light pipe. The method utilizes a two shot molding process to create the button housing and the light pipe. The method includes the steps of injecting a first shot of resin A wherein resin A is a resin not allowing chrome to adhere to it, allowing resin A to cool, injecting a second shot of resin B into the mold, and continuing to chrome plate the entire button wherein chrome only adheres to resin B. A light pipe formed by resin A remains transparent or translucent allowing light to shine through from a light to the eye of a user. Chrome plating adheres to resin B providing for a polished finish.

### FIELD OF THE INVENTION

This invention relates generally to a method to manufacture buttons. In particular, this invention relates to a method to manufacture a button using a two shot molding process.

### BACKGROUND OF THE INVENTION

It is well known in the art to use a plurality of buttons on instrument panels within a vehicle wherein those buttons have chrome plating. These buttons commonly require a plurality of elements to be joined together after certain elements have received chrome plating. As shown in FIG. 2 of the prior art, a button 20 on a vehicle radio is provided having two main parts. The two main parts include main housing 22 and light pipe 24. The main housing 22 and the light pipe 24 fit together in an interlocking fashion. As shown by directional arrow 26, the light pipe 24 fits within the aperture 28 of the main housing 22. The light pipe 24 is transparent or translucent to allow light to shine through the light pipe 24 and able to be viewed by a user of the vehicle.

Fitting a plurality of elements together to form a button having a light pipe and a chrome plated element is difficult to produce, costly, and creates a plurality of problems. The gap created between the light pipe 24 and the main housing 22 produces rattling or other noise creating a common complaint by the user. Furthermore, the gap created between the main housing 22 and the light pipe 24 frequently allows light to escape before it is filtered through the light pipe 24. This escaping light produces an undesirable appearance on the radio. Accordingly, it is desirable to inexpensively produce a chrome button having an integrated light pipe with improved fit and finish.

### SUMMARY OF THE INVENTION

The present invention provides a method for molding and chrome plating a button having an integrated light pipe. The method utilizes a two shot molding process to create the button housing and the light pipe. The method includes the steps of injecting a first shot of resin A wherein resin A is a resin not allowing chrome to adhere to it, allowing resin A to cool, injecting a second shot of resin B into the mold, and continuing to chrome plate the entire button wherein chrome only adheres to resin B. A light pipe formed by resin A remains transparent or translucent allowing light to shine through from a light to the eye of a user. Chrome plating adheres to resin B providing for a polished finish.

### BRIEF DESCRIPTION OF THE DRAWINGS

FIG. 1 is a frontal view of a radio assembly having a button including a button housing and a light pipe;

FIG. 2 is an exploded perspective view of the prior art;

FIG. 3 is a perspective view of the button having a light pipe and a button housing;

FIG. 4 is a cross-sectional view along the section 4-4 of a button having a button housing and a light pipe; and

FIG. 5 is a flowchart depicting the method to create a button using a two shot molding process.

### DETAILED DESCRIPTION OF THE PREFERRED EMBODIMENTS

This invention provides for a method using a two shot molding process to create a button for a radio assembly wherein the two shot process creates a button housing and a light pipe using two different resins wherein chrome plating only adheres to one of the resins. The two shot molding process creates a polished and finished look of the chrome, eliminates noise heard by the user, and eliminates the subassembly of the button housing and the light guide to provide for easier manufacturing processes.

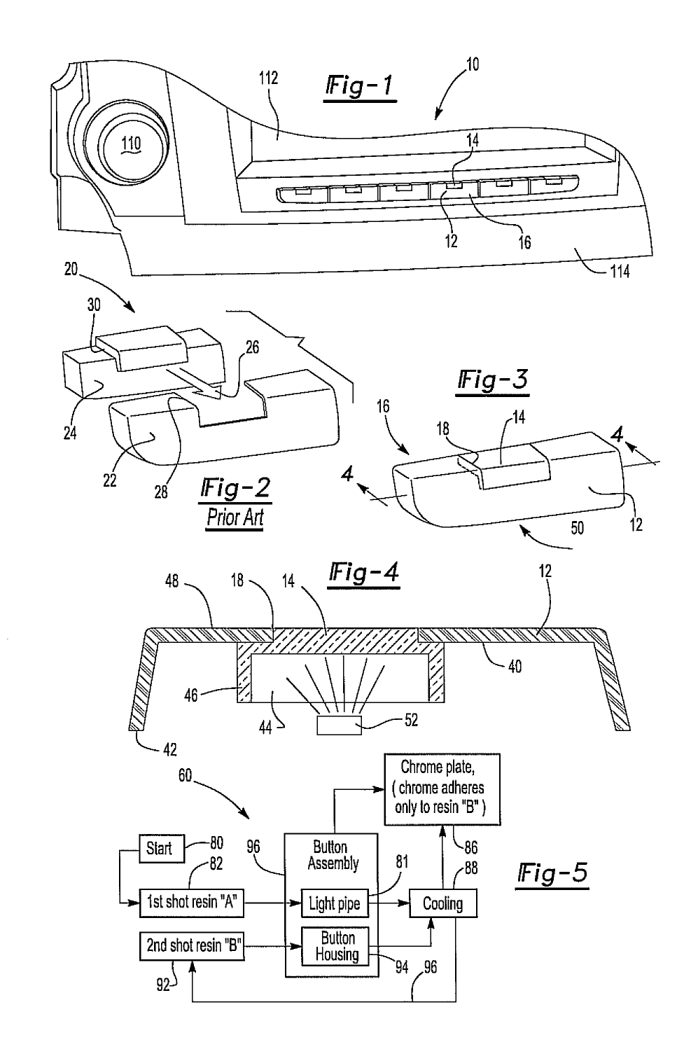

A radio assembly 10 is provided having a plurality of buttons 16, as shown in FIG. 1. The button 16 includes a housing 12 and a light pipe 14. The buttons are mounted to a radio having a display 112 and turn dial 110. The radio and display 112 are mounted within an instrument panel 114 within a vehicle interior. A light provided behind the button 16 travels through the light pipe 14 and is viewable by the user of the vehicle housing the radio assembly 10. The button assembly 16, as shown in FIG. 3, includes the light pipe 14 and the button housing 12. The resin used to create the button housing 12 is a resin allowing chrome to stick to the exterior of the button housing 12. Resins allowing chrome plating are commonly known in the art as plateable plastic resins. Various plateable plastic resins include polycarbonate, ABS, polycarbonate/ABS blend, polyethermide, polyphthalamide (nylon), polystyrene, polyethersulfone (PES), polypropylene, Noryl, liquid crystal polymers (LCP), and graphite-epoxy composites.

As an example of the present embodiment, the resin used to create the housing 16 is polycarbonate/ABS blend. Furthermore, the resin used to create the light pipe 14 is polypropylene (PP). During the chrome plating process, chrome does not stick to the polypropylene (PP) used to make the light pipe 14. Furthermore, during the chrome plating process, chrome does stick to the polycarbonate/ABS blend used to make the housing 16.

The resin used to create the light pipe 14 must be a resin not allowing chrome to stick to the resin. The resin used in a light pipe 14 is typically a clear resin having transparent or at least translucent qualities.

As shown in FIG. 3, the space between the button housing 12 and the light pipe 14 is nonexistent. The space 18 is entirely eliminated using the two shot molding process discussed herein. Elimination of a gap in the space 18 decreases noise heard by the user and eliminates any light escaping from the light source 52. Using the two shot molding process, light from the light source 52 exits only through the light pipe 14. The elimination of the space 18 provides for a highly desirable appearance to the user.

As shown in FIG. 4, a light source 52 is provided behind the button assembly 16. The light source 52 shines through the light pipe 14. No light escapes through the button housing 12 since the button housing 12 is chrome plated. The light source 52 may be an LED, a light bulb, a light pipe, or any additional source of light.

The housing 12 includes a first surface 48. The first surface 48 is opaque and chrome plated so as not to allow any light to pass through. The first surface 48 faces the user of the buttons 16. The housing further includes an arm 42 allowing easy installment of the button assembly 50 into a radio. The housing 12 further includes a second surface 40. The second surface 40 faces the light source 52.

The light pipe 14 may be filled completely or open as shown by the open space 44. In an alternative embodiment, the open space 44 is filled with a clear resin which allows light from the light source 52 to pass through.

The method according to the present invention is illustrated in the flowchart as shown in FIG. 5. A mold is used to create the completed button assembly. At the start 80, a first shot of resin A 82 is injected into the mold to create the light pipe 84. Resin A is comprised of a resin wherein chrome will not adhere to the resin. Once resin A is cooled 86, a second shot of resin B 92 is injected into the mold. This second shot forms the button housing 94. The resin B is a resin allowing for chrome during a chrome plating process to adhere to the resin. The light pipe 14 and the button housing 12 are now one complete piece. The button assembly 16 then completes a chrome plating process 88. The chrome plating process 88 is well known in the art and is a technique of electroplating a thin layer of chromium onto an object. The chrome provides a decorative layer, eases cleaning procedures, and increases surface hardness. The complete button 16 is placed in a chrome plating vat or bath and a plating current is applied allowing the chromium to stick only to resin B of the button housing. Once chrome plating is complete, the light pipe 14 remains clear allowing light from the light source 52 to shine through and the button housing 16 includes a polished chrome finish. Other chrome plating methods such as cyanide baths, chrome painting, hexavalent chromium plating, or other similar chrome plating procedures may be used.

In an alternative embodiment, the molding process may include the first shot of the resin to form the button housing first, allow the resin used for the button housing to cool, and then completing the button assembly with a second shot of resin to form the light pipe. The order in which the two button assembly subparts are molded is negotiable.

The invention is not restricted to the illustrative examples and embodiments described above. The embodiments are not intended as limitations on the scope of the invention. Methods, apparatus, compositions, and the like described herein are exemplary and are not intended as limitations on the scope of the invention. Changes therein and other uses will occur to those skilled in the art. The scope of the invention is defined by the scope of the claims.

I claim:

1. A method for manufacture of chrome plated button assembly using an injection molding process and a mold to manufacture the button, the process using at least two compositions of resin, the method comprising the steps of:
injecting a first resin into the mold, the first resin forming a first element
cooling the first resin;
injecting a second resin into the mold allowing the second resin to adhere to the first resin, the second resin forming a second element, the first resin and the second resin molded as a one piece button assembly;
cooling the second resin; and
applying the chrome plating process to the one piece button assembly, chrome only adhering to the second resin.

2. The method according to claim 1, wherein the first element is a light pipe.

3. The method according to claim 1, wherein the second element is a housing.

4. The method according to claim 1, wherein the chrome plating process is a chrome bath.

5. The method according to claim 1, wherein the first resin is clear allowing light to pass through.

6. The method according to claim 5, wherein the first resin is not chrome platable.

7. A method for manufacture of chrome plated button assembly using an injection molding process and a mold to manufacture the button, the process using at least two compositions of resin, the method comprising the steps of:
injecting a first resin into the mold, the first resin forming a first element
cooling the first resin;
injecting a second resin into the mold allowing the second resin to adhere to the first resin, the second resin forming a second element, the first resin and the second resin molded as a one piece button assembly;
cooling the second resin; and
applying the chrome plating process to the one piece button assembly, chrome only adhering to the first resin.

8. The method according to claim 7, wherein the first element is a housing.

9. The method according to claim 7, wherein the second element is a light pipe.

10. The method according to claim 7, wherein the chrome plating process is a chrome bath.

11. The method according to claim 7, wherein the second resin is clear allowing light to pass through.

12. The method according to claim 11, wherein the second resin is not chrome platable.
